(19) United States
(12) Patent Application Publication
(10) Pub. No.: US 2007/0243735 A1
(43) Pub. Date: Oct. 18, 2007

(54) Module Card Ejecting Mechanism

(76) Inventor: Aruong Juang, Taoyuan Hsien (CN)

Correspondence Address: HARRINGTON & SMITH, PC, 4 RESEARCH DRIVE, SHELTON, CT, 06484-6212, US

(21) Appl. No.: 10/585,145

(22) PCT Filed: Dec. 29, 2004
(86) PCT No.: PCT/SG04/00428

§ 371 Date: May 7, 2007

(30) Foreign Application Priority Data
Dec. 30, 2003 (TW) 092137486

(51) Int. Cl. H01R 13/62

(52) U.S. Cl. 439/159

(57) ABSTRACT

The present invention discloses a module card ejecting mechanism including an ejecting plate and a push-push ejecting mechanism, wherein the push-push ejecting mechanism substantially includes a housing, a pushing rod, a rotator, a spring and an end cap.

### FIELD OF THE INVENTION

The present invention relates to a module card ejecting mechanism for a module card (e.g. express card) slot.

### DESCRIPTION OF THE PRIOR ART

A typical module card ejecting mechanism disclosed in U.S. Pat. No. 5,871,365 employs a push-push mechanism with a heart-shaped cam structure. Although this structure can achieve the intended effectiveness, it is somewhat complicated, relatively high in manufacturing cost and takes up a larger space.

Thus, it is necessary to provide a module card ejecting mechanism which is simplified and easy to be manufactured.

### SUMMARY OF THE INVENTION

According to a preferred embodiment of the present invention, a module card ejecting mechanism comprises an ejecting plate and a push-push ejecting mechanism. The push-push ejecting mechanism comprises:

(1) a housing including a channel having a guiding section, said guiding section having a push-out engagement part and a push-in engagement part which are cross-configured along an annular direction;

(2) a pushing rod including a pilot flange and adaptable for allowing the pushing rod to slidably but non-rotatably engage with the guiding section;

(3) a rotator configured in a way that it is cyclically, alternatively engaged with the cross-configured push-out engagement part and push-in engagement part; and

(4) a spring for elastically urging against the rotator.

This module card ejecting mechanism makes use of the interactions between the rotator configuration, the pilot flange and the guiding section, thereby causing the rotator to alternatively rotate to and engage with the first rotating position or the second rotating position, so as to drive said pushing rod to move to the card-withdrawing position or the card-inserting position.

The further characteristics of the present invention can be further appreciated by the following detailed description and the description of the drawings.

### BRIEF DESCRIPTION OF THE DRAWINGS

FIG. 1a is a schematic view of the module card ejecting mechanism 1 used with a module card connector assembly C;

FIG. 1b illustrates an assembled state of FIG. 1a;

FIG. 2 is a schematic view showing the relationship between the head end H, the terminal T and the ejecting plate 10 of FIG. 1, which shows that the ejecting plate 10 can slide within the head end H;

FIG. 3a is an exploded view of the module card ejecting mechanism 1;

FIG. 3b is a partially sectional view of the push-push ejecting mechanism 20;

FIG. 4a is a partially sectional view of the pushing rod 40 located at the “card-withdrawing position”;

FIG. 4b is a partially sectional view of the pushing rod 40 located at the “card-inserting position”; and

FIGS. 5a and 5b are the schematic views of the module card ejecting mechanism 1 used with a dual-width module card connector assembly and a mono-width module card connector assembly.

### DETAILED DESCRIPTION OF PREFERRED EMBODIMENTS

As shown in the drawings, the module card ejecting mechanism 1 of the present invention can be used in a module card connector assembly C.

After a module card P is positioned into the card slot S of the module card connector assembly C, the module card P can be coupled to the head end H of the module card connector assembly C or can be took out therefrom by repeatedly applying a pushing force thereon.

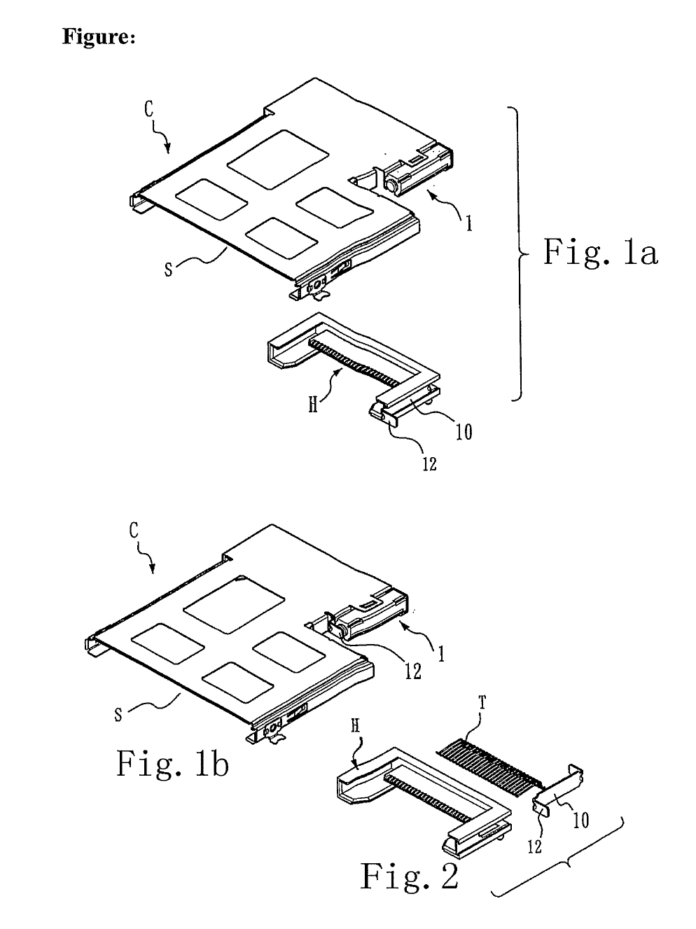

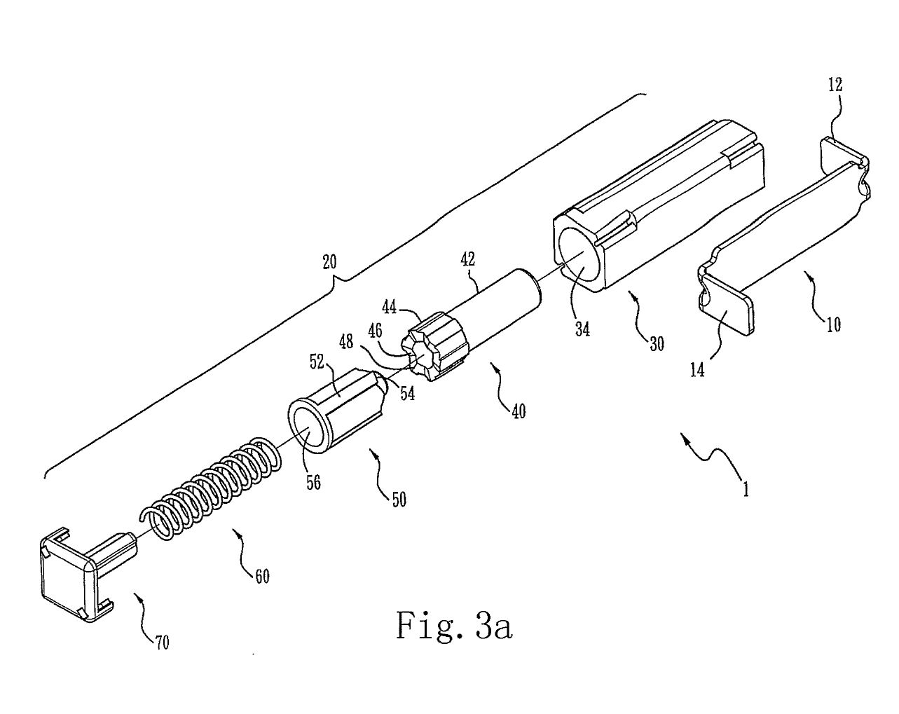

As shown in FIGS. 1a to 3b, the module card ejecting mechanism 1 mainly comprises an ejecting plate 10 and a push-push ejecting mechanism 20.

The ejecting plate 10 is mounted onto the head end H of the module card connector assembly C, and it can slide along the card-moving direction of the module card connector assembly C. The ejecting plate 10 includes a card contact part 12 for operational interactions with the inserting and withdrawing operations of an inserted card (e.g. a module card), and a card coupling part 14 mechanically coupled to the push-push ejecting mechanism. The card contact part 12 is associated with the coupling part 14.

The push-push ejecting mechanism 20 comprises a housing 30, a pushing rod 40, a rotator 50, and a spring 60. The end of the push-push ejecting mechanism 20 can be sealed by a separated end cap 70.

The housing 30 has an inner wall 32, which defines a channel 34 with a guiding section 36 surrounding the inner wall 32. The guiding section 36 includes a push-out engagement part and a push-in engagement part which are cross-configured along an annular direction and coupling to the rotator 50. The guiding section 36 preferably includes an annularly-configured guiding means between the push-out engagement part and a push-in engagement part, which is capable of rotating the rotator 50 and driving the same to engage with the push-out engagement part or the push-in engagement part. According to the preferred embodiments of the present invention, said push-out engagement parts are preferably in the form of a plurality of annularly-disposed elongated slots 362, wherein each elongated slot 362 is preferably formed with a stopping wall 363. The push-in engagement parts are preferably in the form of a plurality of annularly-disposed short slots 364, wherein each short slot 364 is preferably formed with a stopping wall 365. The guiding means is preferably in the form of a plurality of guiding vanes 366 configured along an annular direction, wherein each guiding vane 366 preferably comprises an inclined guiding surface 367. Each guiding vane 366 intervenes between an elongated slot 362 and an a short slot 364.

The pushing rod 40 has a free end 42 and a pilot flange 44. The pilot flange 44 may couple to the guiding section 36 in a slidable but non-rotatable way, such that the pushing rod 40 can axially, non-rotatably move in the channel 34. According to the preferred embodiments of the present invention, the pilot flange 44 is preferably formed with a plurality of annylarly-arranged convex guiding blocks 442 which can slide along the corresponding guide slots (not shown) formed on the guiding section 36, so as to allow the pushing rod 40 to axially move in the channel 34. To provide a simplified guiding section 36 structure, guide slots in the form of elongated slots 362 and short slots 364 are recommended. The pilot flange 44 is formed with a plurality of generally V-shaped, annularly-disposed guiding grooves 46, and a plurality of annularly-disposed groove tops 48, wherein the guiding grooves 46 and the groove tops 48 are cross-arranged such that each groove top 48 intervenes between two adjacent guiding grooves 46. The guiding grooves 46 and the groove tops 48 can guide the rotator 50 to rotate, as described below in details.

The rotator 50 preferably comprises a plurality of annularly-disposed ribs 52, and a plurality of annularly-arranged oblique surfaces 54. The number of ribs 52 is the same as the number of the elongated slots 362 (push-out engagement part) or the short slots 364 (push-in engagement part) of the guiding section 36, and the ribs 52 allow the rotator 50 to couple with the elongated slots 362 or short slots 364. The oblique surface 54 can slide on the guiding surface 367 of the guiding vane 366 to guide the rotator 50 to slide and rotate at the same time. The oblique surface 54 is preferably formed at the end of the rib 52.

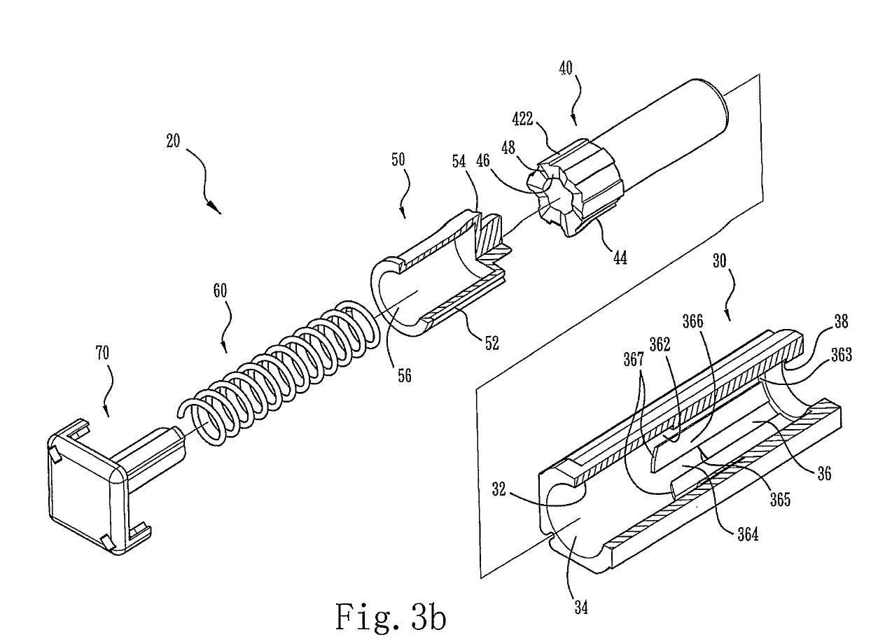

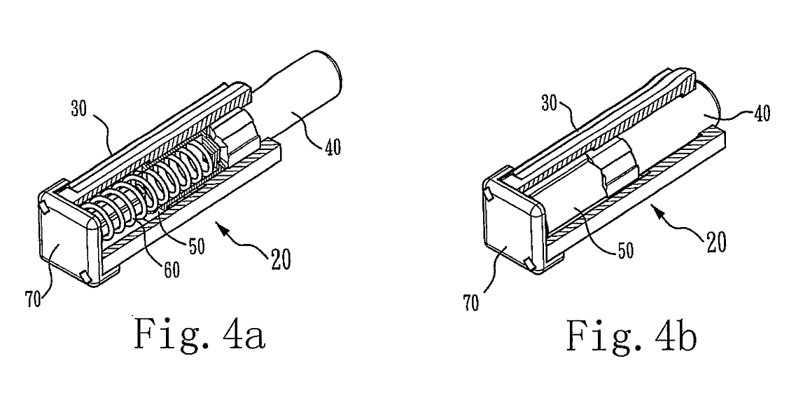

As shown in the preferred embodiment of FIG. 3a and 3b, when assembling the module card ejecting mechanism 1, the guiding block 442 is aligned with the elongated slots 362 and the short slots 364, and then the pushing rod 40 is guided into the housing 30. The groove tops 48 of the pilot flange 44 are located on the elongated slots 362 and the short slots 364 (the number of the groove tops 48 is the sum of the numbers of the elongated slots 362 and the short slots 364). The position of the stopping wall 363 on the elongated slot 362 forms the final position of the pushing rod 40, which is defined as card-withdrawing position (as shown in FIG. 4a). Additionally, the housing 30 can provide a stop shoulder 38 instead of the stopping wall 363 defining the final position of the pushing rod 40. The stop shoulder 38 can be in the form of a shield wall as shown in FIG. 3b. Alternatively, the stop shoulder 38 can be formed into a tapering wall/reducing wall (not shown), and correspondingly, the free end 42 of the pushing rod 40 can be formed into a complementary widening rod which stops and fits the tapering wall, such that when the free end 42 of the pushing rod 40 passes through the tapering wall, it will be restricted by the reducing caliber. After the pushing rod 40 is mounted and positioned, the rotator 50 is disposed in the housing 30, with the ribs 52 sliding into the elongated slot 362 and the oblique surface 54 docking to the groove top 48 on the elongated slot 362. Finally, the spring 60 is disposed into the hole 56 of the rotator 50 to elastically urge against the rotator 50, and subsequently the end cap 70 and the ejecting plate 10 are assembled to constitute the module card ejecting mechanism 1.

Prior to use, the ribs 52 of the rotator 50 are coupled to the elongated slots 362 (push-out engagement part) and located at the first rotating position. During use, a pushing force applied to the card contact part 12 of the ejecting plate 10 can be delivered to the pushing rod 40, and therefore push the rotator 50. With the elastically biasing of the spring 60, the rotator 50 departs from the elongated slot 362 under the guidance of the pilot flange 44 of the pushing rod 40 and of the ribs 52. Once the ribs 52 depart from the elongated slots 362, the oblique surfaces 54, which originally docks to the groove top 48 on the rotator 50, correspondingly slide into the generally V-shaped guiding groove 46, so that the rotator 50 slightly rotates forward with the oblique surfaces 54 facing the guiding vanes 366 of the guiding section 36. If the pushing force is released at this time, and then the oblique surfaces 54 are pushed backward by the elastic force of the spring 60 and thus slide on the guiding surfaces 367 of the guiding vanes 366, finally engage with short slots 364 (push-in engagement part) and secured at a second rotating position. The pushing rod 40 therefore correspondingly moves into a card-inserting position (as shown in FIG. 4b). At this time, the oblique surfaces 54 of the rotator 50 align with the groove tops 48 of the pilot flange 44.

When the rotator 50 is fixed at the second rotating position, another pushing force applied to the ejecting plate 10 (intended to push the module card P out of the head end H of the card slot S) can be delivered into the pushing rod 40 and thus push the rotator 50. The oblique surfaces 54 of the rotator 50 are pushed and ejected by the groove tops 48. Once the oblique surfaces 54 depart from the short slots 364, they slide into the generally V-shaped guiding grooves 46 on the pushing rod 40, slightly rotate the rotator 50 forward, with the oblique surfaces 54 facing another guiding vanes 366. At this time, if the pushing force is released, the oblique surfaces 54 would be pushed backward by the elastic force of the spring 60, and slide on another guiding surfaces 367 on another guiding vanes 366, and finally slide into the elongated slots 362 to go to the first rotating position again. Thus the pushing rod 40 is correspondingly pushed backward to the card-withdrawing position (as shown in FIG. 4a) as well and elastically eject the ejecting plate 10 back, so that the module card can be withdrawn form the slot.

By this way, the rotator 50 makes use of the interactions between its configuration, the pilot flange and the guiding section, thereby alternatively rotating to and engage with the first rotating position or the second rotating position, so as to drive said pushing rod to move to the card-withdrawing position or the card-inserting position.

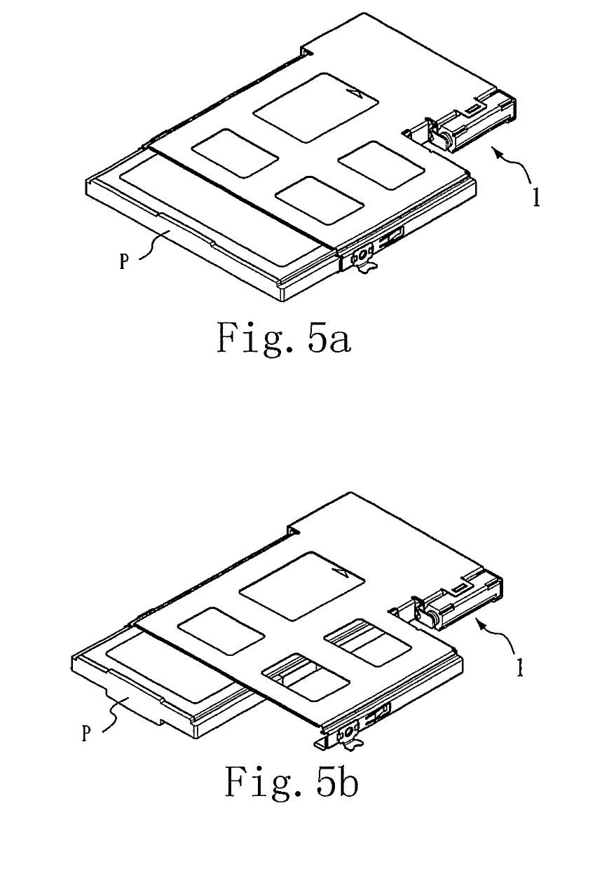

The present invention also employs a pair of module card ejecting mechanism 1 assembled on the module card connector assembly C to achieve better effects. Additionally, as shown in FIGS. 5a and 5b, the module card ejecting mechanism 1 can be applied to the dual-width module card connector assembly or the mono-width module card connector assembly. These and other similar variations all fall within the sprits and characteristics of the present invention. Thus, the embodiments mentioned above are considered to be exemplary but not intended to limit the invention. As long as all variations follow or have equal effects to the meaning and scope of the Claims, they should be all included in the scope of the invention.

1. A module card ejecting mechanism comprising:
an ejecting plate coupled to a module card connector assembly and slidable along a card-moving direction of the module card connector assembly;
a push-push ejecting mechanism coupled to the module card connector assembly; said push-push ejecting mechanism comprising:
a housing having an inner wall defining a channel, said channel including a guiding section surrounding the inner wall, said guiding section having a push-out engagement part and a push-in engagement part which are cross-configured along an annular direction;
a pushing rod axially movable in the channel, said pushing rod including a free end and a pilot flange for slidable but non-rotatable engagement with the guiding section;
a rotator axially movable in the channel, said rotator being configured in a way that it is cyclically, alternatively engaged with the cross-configured push-out engagement part and push-in engagement part;
a spring elastically urging against the rotator;
wherein the ejecting plate is mechanically coupled to the pushing rod of the pushpush ejecting mechanism such that a repeated pushing force exerted on the ejecting plate allows the rotator to alternatively slide to the push-out engagement part or the push-in engagement part under the guidance of the pilot flange of the pushing rod, thereby causing said rotator to rotate to a first rotating position or a second rotating position, to correspondingly move the pushing rod to a card-withdrawing position or a card-inserting position.

2. The module card ejecting mechanism according to claim 1, wherein the push-out engagement part includes a plurality of annularly-disposed elongated slots.

3. The module card ejecting mechanism according to claim 2, wherein each elongated slot is installed with a stopping wall.

4. The module card ejecting mechanism according to claim 1, wherein the push-in engagement part is a plurality of annularly-disposed short slots.

5. The module card ejecting mechanism according to claim 1, wherein an annularly configured guiding means is provided between the cross-configured push-out engagement part and push-in engagement part.

6. The module card ejecting mechanism according to claim 5, wherein the guiding means includes a plurality of guiding vanes configured along an annular direction.

7. The module card ejecting mechanism according to claim 6, wherein each guiding vane is formed with an inclined guiding surface.

8. The module card ejecting mechanism according to claim 2, wherein the rotator includes a plurality of annularly-disposed ribs.

9. The module card ejecting mechanism according to claim 1, wherein the housing includes a stop shoulder.

10. The module card ejecting mechanism according to claim 9, wherein the stop shoulder is shaped into a tapering wall and the free end of the pushing rod is shaped into a complementary widening rod fitted with the tapering wall.

11. The module card ejecting mechanism according to claim 1, wherein the pilot flange includes a plurality of generally V-shaped, annularly-disposed guiding grooves and a plurality of annually-disposed groove tops; wherein said guiding grooves and said groove tops are cross-arranged such that each of the latter ones is positioned between two of adjacent former ones.

12. The module card ejecting mechanism according to claim 8, wherein the rotator includes a plurality of annularly-arranged oblique surfaces, such that when the rotator is located at the first rotating position or at the second rotating position, each oblique surface docks on one of said groove tops.

13. The module card ejecting mechanism according to claim 1, wherein the push-out engagement part includes a plurality of annularly-disposed elongated slots, and wherein the rotator is formed with a plurality of ribs each of which is slidable in the elongated slots and formed with an oblique surface.

14. The module card ejecting mechanism according to claim 1, wherein the end of the housing is sealed by a separate end cap.

15. A module card connector assembly, comprising: a card slot and a head end, wherein the head end is provided with one or a pair of module card ejecting mechanisms as claimed in claim 1.
